(19) United States
(12) Patent Application Publication
(10) Pub. No.: US 2011/0132338 A1
(43) Pub. Date: Jun. 9, 2011

(54) IGNITION COIL FOR AN ENGINE

(75) Inventors: Ji Hyoung Kim, Incheon (KR); Jong Wook Lee, Gunpo (KR); Kyung Sick Cho, Yeongi-Gun (KR); Ki Su Lim, Yeongi-Gun (KR)

(73) Assignees: HYUNDAI MOTOR COMPANY, Seoul (KR); YURATECH CO., LTD., Yeongi-Gun (KR)

(21) Appl. No.: 12/814,773

(22) Filed: Jun. 14, 2010

(30) Foreign Application Priority Data
Dec. 4, 2009 (KR) 10-2009-0119871

(51) Int. Cl. H01F 38/12

(52) U.S. Cl. 123/634

(57) ABSTRACT

The present invention features an ignition coil for an engine, in which a small-sized condenser is directly installed in an LV pin (low voltage pin) of the ignition coil and efficiently removes noises, is disclosed. In preferred embodiments, the ignition coil includes an outer casing defining the appearance of the ignition coil, a first spool inserted in the outer casing and having a second spool therein, an LV pin installed in an upper portion of the first spool, and a condenser installed in the LV pin.

### CROSS-REFERENCE TO RELATED APPLICATION

This application claims under 35 U.S.C. §119(a) the benefit of Korean Patent Application No. 10-2009-0119871 filed Dec. 4, 2009, the entire contents of which are incorporated herein by reference.

### BACKGROUND OF THE INVENTION

1. Field of the Invention

The present invention relates, generally, to an ignition coil for an engine and, more particularly, to an ignition coil for an engine, which can efficiently remove noises generated therefrom.

2. Description of the Related Art

An ignition coil of an engine is used for supplying high voltage to an ignition plug of the engine. Preferably, the ignition coil is suitably mounted in a head cover of the engine and is suitably connected to the ignition plug installed in a combustion chamber.

For example, a conventional condenser connection structure for four-cylinder engines is described herein with reference to FIG. 1. As shown in FIG. 1, four ignition coils 10 having respective harness connectors 11 are suitably installed in a four-cylinder engine. The harness connectors 11 of the four ignition coils 10 are suitably connected to a single wiring harness 20. The end of the wiring harness 20, which is opposite the harness connectors 11, is suitably connected to a condenser connector 30 having a condenser 40.

Preferably, the condenser 30 functions to suitably remove the noises generated from the ignition coils 10. in the conventional condenser connection structure for four-cylinder engines the ignition coils 10 are excessively remote from the condenser 40, and so the structure cannot efficiently remove the noises.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In preferred aspects, the present invention provides an ignition coil for an engine, in which a small-sized condenser is directly installed in an LV pin (low voltage pin) of each ignition coil such that the condenser can efficiently remove noises generated from the ignition coil, with a ground pin being added to the LV pin and being suitably grounded to a car body or to an engine head cover, thus suitably increasing the noise removing effect.

According to preferred embodiments of the present invention, there is provided an ignition coil for an engine, suitably installed in an engine head cover and used for supplying high voltage to an engine ignition plug, preferably comprising an outer casing forming an appearance of the ignition coil; a first spool suitably inserted in the outer casing, with a second spool suitably installed in the first spool; an LV pin suitably installed in an upper portion of the first spool; and a condenser suitably installed in the LV pin and removing noises.

Preferably, the LV pin may comprise a signal pin suitably connected to an engine control unit, a power source pin suitably connected to a power supply unit, and a ground pin for grounding. Further, the condenser may preferably be placed between the power source pin and the ground pin such that the condenser suitably connects the power source pin to the ground pin.

In certain preferred embodiments, preferably, in the ignition coil, a lug may be provided in an upper portion of the outer casing, with a ground bolt locked to the lug and connected to a car body or to the engine head cover, the ground bolt being connected to the ground pin.

Further, preferably, in the ignition coil, a connector may be provided in an upper portion of the first spool such that the connector suitably connects a wiring harness to the LV pin. Further, a shock absorbing seal may be suitably installed between the connector and the first spool such that the shock absorbing seal can absorb an external shock applied to the condenser.

According to preferred embodiments of the present invention as described herein, in the above-mentioned ignition coil for an engine, the small-sized condenser is directly installed in the LV pin of the ignition coil, thus efficiently removing noises. Further, the ground pin is suitably added to the LV pin and is grounded to the car body or to the engine head cover, thus increasing the noise removing effect.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is an exemplary view illustrating the conventional connection between ignition coils and a condenser for an engine; and

FIG. 2 is an exemplary view illustrating an ignition coil for an engine according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE INVENTION

As described herein, in preferred aspects, the present invention features an ignition coil for an engine comprising an outer casing, a first spool inserted in the outer casing, a second spool installed in the first spool, an LV pin (low voltage pin) installed in an upper portion of the first spool; and a condenser.

In one embodiment, the ignition coil is installed in an engine head cover and used for supplying a high voltage to an engine ignition plug.

In another embodiment, the outer casing forms an appearance of the ignition coil.

In another further embodiment, the condenser is installed in the LV pin and removes noises.

Hereinbelow, an ignition coil for an engine according to preferred embodiments of the present invention is described with reference to the accompanying drawings.

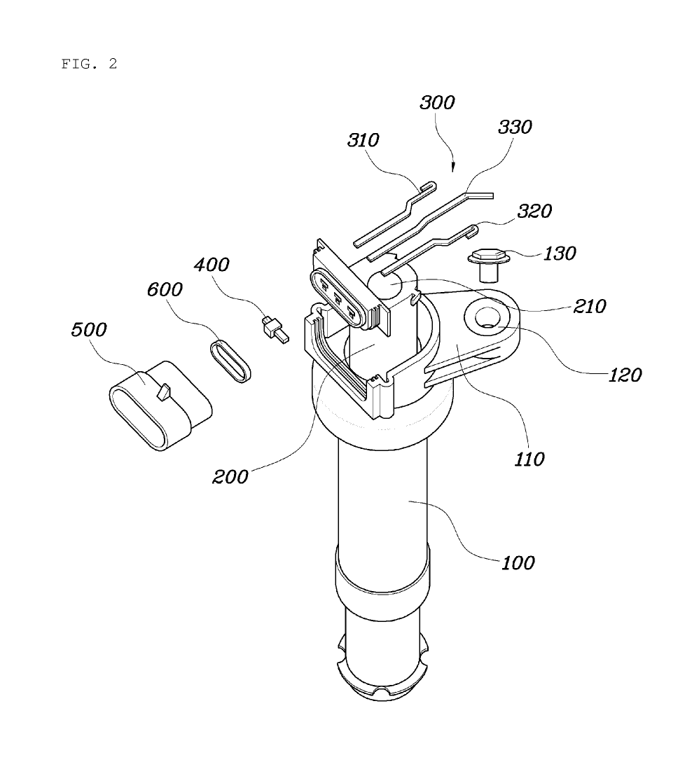

In certain exemplary embodiments, for example as shown in FIG. 2, the ignition coil for an engine according to the present invention is suitably installed in an engine head cover and supplies high voltage to an engine ignition plug, and comprises an outer casing 100, a first spool 200, a second spool 210, an LV pin 300 and a condenser 400.

Preferably, the outer casing 100 has a cylindrical shape, with the first spool 200 inserted therein. Preferably, a first coil (not shown) is suitably wound around the first spool 200.

Preferably, the second spool 210 is suitably inserted in the first spool 200, with both a second coil (not shown) wound around the second spool 210 and a magnetic core (not shown) suitably installed in the second spool 210.

Preferably, the above-mentioned ignition coil suitably induces a high voltage both by electromagnetic induction between the first coil and second coil and by electromagnetic induction between the first coil and the magnetic core and suitably supplies the high voltage to the ignition plug.

Preferably, the LV pin (low voltage pin) 300 suitably receives both a signal transmitted from an engine control unit and electricity supplied from a power supply unit. According to preferred embodiments of the present invention, the LV pin 300 comprises a signal pin 310 suitably connected to the engine control unit and a power source pin 320 suitably connected to the power supply unit. Further, it is preferred that a ground pin 330 be added to the LV pin 300. In certain embodiments, it is preferred that the ground pin 330 is placed between the signal pin 310 and the power source pin 320.

Preferably, the condenser 400 removes both ignition noises generated from the ignition coil and other noises introduced thereto from the outside. Preferably, the condenser 400 is a small-sized condenser and is placed such that the condenser 400 is located between the power source pin 320 and the ground pin 330 and suitably connects the power source pin 320 to the ground pin 330.

In further preferred embodiments, the location of the condenser 400 between the power source pin 320 and the ground pin 330 suitably functions to reduce the thermal stress of the condenser 400 because the heat transfer from the engine to the power source pin 320 is less than that from the engine to the signal pin 310.

Preferably, a lug 110 is suitably provided in an upper portion of the outer casing 100 and a bushing 120 is suitably installed in the lug 110. Preferably, a ground bolt 130 is locked to the bushing 120 and is suitably connected either to a car body or to the engine head cover and, therefore, is negatively grounded. Preferably, the ground bolt 130 is suitably connected to the ground pin 330 with a minimum distance therebetween, so that the condenser 400 can efficiently remove the noises passing therethrough without letting the noises propagate to the surroundings.

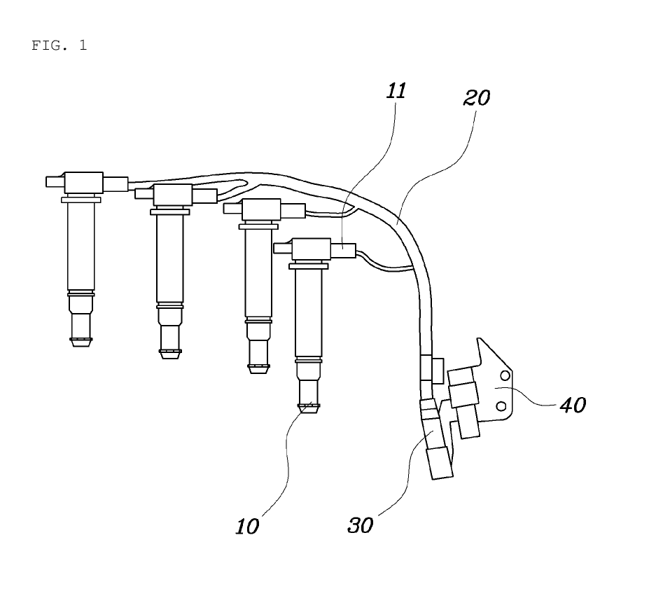

According to further preferred embodiments, a connector 500 for connecting the LV pin 300 to a wiring harness 20 (see FIG. 1) is suitably installed in an upper portion of the first spool 200. In further embodiments, a shock absorbing seal 600 is suitably installed between the connector 500 and the first spool 200 and absorbs an external shock applied to the condenser 400.

Preferably, the shock absorbing seal 600 also has a waterproof seal function of protecting the ignition coil from moisture and may preferably be made of a rubber material mixed with ferrite powder.

As described herein, in the ignition coil for an engine according to the present invention, a small-sized condenser is directly installed in an LV pin of the ignition coil such that the condenser can suitably remove noises generated from both a first spool and a second spool within a minimum distance, thus efficiently removing the noises. Further, a ground pin is preferably added to the LV pin and is grounded to a car body or to an engine head cover, thus suitably increasing the noise removing effect. Further, a shock absorbing seal is preferably installed in the ignition coil and adsorbs an external shock applied to the condenser, thus preventing the condenser from becoming damaged or broken.

Although certain exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An ignition coil for an engine, installed in an engine head cover and used for supplying a high voltage to an engine ignition plug, comprising:
an outer casing forming an appearance of the ignition coil;
a first spool inserted in the outer casing, with a second spool installed in the first spool;
an LV pin (low voltage pin) installed in an upper portion of the first spool; and
a condenser installed in the LV pin and removing noises.

2. The ignition coil for an engine of claim 1, wherein
the LV pin comprises a signal pin connected to an engine control unit, a power source pin connected to a power supply unit, and a ground pin for grounding, and
the condenser is placed between the power source pin and the ground pin and connects the power source pin to the ground pin.

3. The ignition coil for an engine of claim 2, wherein a lug is provided in an upper portion of the outer casing, with a ground bolt locked to the lug and connected to a car body or to the engine head cover, the ground bolt being connected to the ground pin.

4. The ignition coil for an engine as set forth in claim 1, wherein a connector is provided in an upper portion of the first spool and connects a wiring harness to the LV pin, and a shock absorbing seal is installed between the connector and the first spool and absorbs an external shock applied to the condenser.

5. An ignition coil for an engine comprising:
an outer casing
a first spool inserted in the outer casing;
a second spool installed in the first spool;
an LV pin (low voltage pin) installed in an upper portion of the first spool; and
a condenser.

6. The ignition coil for an engine of claim 5, wherein the ignition coil is installed in an engine head cover and used for supplying a high voltage to an engine ignition plug.

7. The ignition coil for an engine of claim 5, wherein the outer casing forms an appearance of the ignition coil.

8. The ignition coil for an engine of claim 5, wherein the condenser is installed in the LV pin and removes noises.
